(19) United States
(12) Patent Application Publication
(10) Pub. No.: US 2005/0043872 A1
(43) Pub. Date: Feb. 24, 2005

(54) Control system for a functional unit in a motor vehicle

(76) Inventor: Detlef Heyn, Kirchhain (DE)

Correspondence Address: CARLSON, GASKEY & OLDS, P.C., 400 WEST MAPLE ROAD, SUITE 350, BIRMINGHAM, MI, 48009, US

(21) Appl. No.: 10/903,738

(22) Filed: Jul. 30, 2004

(30) Foreign Application Priority Data
Aug. 21, 2003 (DE) 103 38 458.8

(51) Int. Cl. G01C 21/26

(52) U.S. Cl. 701/36; 701/213

(57) ABSTRACT

A control system for a functional unit in a motor vehicle includes a control unit that communicates with the functional unit. The control unit processes localizing signals from a global positioning system (GPS) and is capable of performing a location-specific setting of the functional unit as a function of the signals.

### REFERENCE TO RELATED APPLICATIONS

The present invention claims the benefit of German Patent Application No. 103 38 458.8, filed Aug. 21, 2003.

### TECHNICAL FIELD

The invention relates to a control system for at least one functional unit in a motor vehicle. More particularly, the invention relates to a control system having a control unit that communicates with the functional unit.

### BACKGROUND OF THE INVENTION

Certain electronic functional units in a motor vehicle are often required to meet special regulations or prescriptions of a given country where the vehicle is to be delivered and operated. For example, drives for anti-pinch systems used in sliding roofs and window lifters have a particular spring rate. The spring rate regulations in Europe are different than those in the United States. Similarly, other functional units (e.g., radio receivers) have parameters and functionalities that need to be adapted to the circumstances and requirements of the particular country in which they will be used.

Currently, functional units are customized for a given country via a fixed programmable country code or a manually produced code implemented through hardware. This customization results in a large number of variants of otherwise identical functional units and their supply lines. Functional units designed to concurrently meet country-specific requirements for multiple countries have been proposed, but these functional units either cannot be implemented practically as actual products or can be implemented only with very high development expenditures in terms of time and money. Moreover, attempts to meet the requirements for multiple countries simultaneously usually result in geographical flexibility of the functional unit at the expense of performance (e.g. lower closing forces in sliding roofs and window lifters) and/or functionality.

There is a desire for a simpler, more effective method to adapt functional units in a vehicle to country-specific requirements.

### SUMMARY OF THE INVENTION

The invention is generally directed to a control system having a control unit that processes a localizing global positioning system (GPS) signal generated by a GPS in a vehicle. The control unit can then set one or more functional units with settings that are a function of the GPS signal. In this context, the phrase “setting of the functional unit” is to be generally understood as switching on/off and/or adapting certain functions of the functional unit to country-specific regulations or prescriptions. The GPS signal provides information regarding a location of the vehicle. A desired setting of the functional unit can therefore be performed automatically by the control unit based on the location information from the GPS signal. As a result, the invention eliminates the need to perform any manual changes in the functional unit before or after the vehicle is delivered to a particular country.

In one example, the inventive control system includes a receiving device for receiving the GPS signal. The receiving device is arranged on the vehicle and connected to the control unit. The receiving device may be part of a vehicular navigation system having the GPS; this allows data that is already required for vehicle navigation to be used for appropriate setting of the functional unit as well.

### BRIEF DESCRIPTION OF THE DRAWINGS

Further features and advantages of the invention will be apparent from the following description of an example embodiment and from the accompanying drawing to which reference is made.

FIG. 1 is a schematic illustration of a control system for a functional unit in a motor vehicle according to one embodiment of the invention.

### DETAILED DESCRIPTION OF THE PREFERRED EMBODIMENTS

The invention is generally directed to a control system that sets one or more functional units based on geographic information provided by a global positioning system (GPS). The control system includes a control unit that processes GPS signals from the GPS and that can set one or more functional units (e.g., switching functions in the functional unit on/off, adapting functions to meet country-specific regulations, etc.) as a function of the GPS signals. The GPS signals allow the exact location of the vehicle to be determined. From this information, a desired setting of the functional unit can be performed automatically by the control unit based on the determined location, eliminating the need to perform any manual changes on the functional units in the vehicle before or after delivery of the vehicle in a given country.

In one example, the control system includes a receiving device for receiving the GPS signals. The receiving device is arranged on the vehicle and connected to the control unit. The receiving device can be part of a vehicular navigation system along with the GPS, making it possible for signals from the GPS to be used for both navigation and appropriate setting of the functional unit.

The control unit may connected to a plurality of functional units. This makes it possible to use the inventive system in, for example, an integrated roof module having several functional units (e.g. a sliding roof control, lighting for the interior space, radio receiver etc.) and with a roof node system that ensures a proper country-specific setting of these functional units.

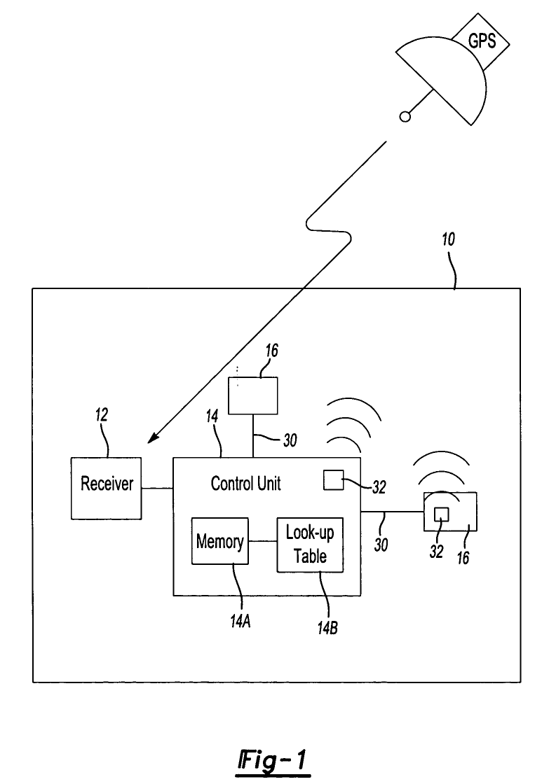

FIG. 1 illustrates one embodiment of a vehicle 10 having a navigation system with a receiving device 12 that receives GPS signals. The receiving device 12 also acts as part of a functional unit control system and is directly or indirectly connected with a control unit 14 in the control system. The control unit 14 sets one or more functional units 16 in the vehicle 10. Possible functional units 16 include, but are not limited to, sliding roof controls, window lifter controls, other controls that incorporate anti-pinch protection, interior space lights, radio receivers, occupant protection devices (e.g. airbag systems, including those in connection with a child seat), motor controls (e.g., engine knock sensors), and locking arrangements. Regardless of the specific functions they carry out, the functional units 16 have characteristics that are subject to country-specific settings.

The receiving device 12 receives the GPS signals, which substantially indicate the degree of longitude and the degree of latitude of the current geographic location of the vehicle 10. This location information is transmitted to the control unit 14. The control unit 14 includes a memory 14a that contains an electronic map. Thus, the control unit 14 can determine the country or region where the vehicle 10 is located based on the longitude and latitude data.

The control unit 14 also includes an electronic look-up table 14b that contains information on specific parameters for each country or region. These parameters are used for a country-specific setting of the functional unit 16. As noted above, the setting of the functional unit 16 is to be generally understood in this context as switching on/off and/or adapting certain functions of the functional unit 16 to country-specific regulations or prescriptions.

Connections between individual components of the control system can be implemented via, for example, conventional signal lines 30, wireless communication devices 32 (e.g., radio transmitting and receiving devices) or a combination of the two. Moreover, the control unit 14 can be connected to a plurality of different functional units 16 to set the country-based characteristics of each functional unit 16 based on the vehicle's geographic location.

The control unit 14 can be located at any place in the vehicle 10 and does not necessarily need to be a component that is separate from any other vehicle component. In one example, each functional unit 16 has its own corresponding integrated control unit 14. An assembly having the functional unit 16 and the control unit 14 is self-sufficient to a certain degree and can be employed independently of a vehicle bus system. It is also possible, however, to connect the control unit 14 to a given bus system through which the decoded GPS signals can be supplied to the control unit 14.

It should be understood that various alternatives to the embodiments of the invention described herein may be employed in practicing the invention. It is intended that the following claims define the scope of the invention and that the method and apparatus within the scope of these claims and their equivalents be covered thereby.

1. A control system for at least one functional unit in a motor vehicle, comprising:
a control unit that communicates with said at least one functional unit, wherein the control unit receives and processes a signal from a global positioning system (GPS) and performs a location-specific setting of said at least one functional unit as a function of the signal.

2. The control system according to claim 1, further comprising a receiving device that receives the signal, wherein the receiving device is arranged on the vehicle and communicates with the control unit.

3. The control system according to claim 2, wherein the receiving device is part of a vehicular navigation system.

4. The control system according to claim 2, further comprising at least one wireless communication device in at least one of the receiving device and the control unit.

5. The control system according to claim 4, wherein said at least one wireless communication device communicates via radio transmission.

6. The control system according to claim 1, further comprising at least one wireless communication device in at least one of the control unit and said at least one functional unit.

7. The control system according to claim 6, wherein said at least one wireless communication device communicates via radio transmission.

8. The control system according to claim 1, wherein said at least one functional unit is at least one selected from the group consisting of a sliding roof drive, a window lifter drive, an interior space light, a radio receiver, an occupant protection device, a motor control and a locking arrangement.

9. The control system according to claim 1, wherein said at least one functional unit comprises a plurality of different functional units, and wherein the control unit is connected to said plurality of different functional units and performs the location-specific setting of each of said plurality of different functional units.

10. A system for at least one functional unit in a motor vehicle, comprising:
a receiving device that receives a global positioning system (GPS) signal, wherein the receiving device forms at least part of a vehicle navigation system; and
a control unit in communication with said at least one functional unit and the receiving device, wherein the control unit receives and processes the GPS signal and performs a location-specific setting of said at least one functional unit as a function of the GPS signal.

11. The system according to claim 10, further comprising at least one wireless communication device in at least one of the receiving device, the control unit, and said at least one functional unit.

12. The system according to claim 11, wherein said at least one wireless communication device communicates via radio transmission.

13. The system according to claim 10, wherein said at least one functional unit is at least one selected from the group consisting of a sliding roof drive, a window lifter drive, an interior space light, a radio receiver, an occupant protection device, a motor control and a locking arrangement.

14. The system according to claim 10, wherein said at least one functional unit comprises a plurality of different functional units, and wherein the control unit is connected to said plurality of different functional units and performs the location-specific setting of each of said plurality of different functional units.
